(19) United States
(12) Patent Application Publication
(10) Pub. No.: US 2012/0285892 A1
(43) Pub. Date: Nov. 15, 2012

(54) Separation Process

(75) Inventors: Philip TUCKETT, Rowville (AU); Trina Margaret DREHER, Rowville (AU)

(73) Assignee: Process Group Pty. Ltd., Rowville (AU)

(21) Appl. No.: 13/464,037

(22) Filed: May 4, 2012

(30) Foreign Application Priority Data
May 10, 2011 (AU) 2011901761

(51) Int. Cl. C02F 1/465; C25B 11/02; C25B 11/04; C25B 9/00; C25B 11/10

(52) U.S. Cl. 210/703; 210/150; 210/151; 204/275.1

(57) ABSTRACT

A bubble generator for generating gas bubbles for a flotation vessel, the bubble generator including at least one inlet through which a water stream can enter the bubble generator; at least one pair of electrodes capable of electrically decomposing water to create gas bubbles; and at least one outlet through which water entrained with gas bubbles can exit the bubble generator. In use, at least one of the outlets is in fluid communication with a flotation vessel containing waste water including contaminants, the gas bubbles being used to separate at least a portion of the contaminants from the waste water in the flotation vessel.

### BACKGROUND OF THE INVENTION

1. Field of the Invention

The present invention generally relates to a separation process, a bubble generator for use in the separation process and a flotation separator. The invention is particularly applicable for reducing the oil-content of “produced water” using a flotation technique and it will be convenient to hereinafter disclose the invention in relation to that exemplary application. However, it should be appreciated that the invention is not limited to that application and could be used to separate various other types of waste water or contaminated water flows.

2. Description of the Prior Art

Water is present in most oil and gas reservoirs. The product extracted from an oil and gas reservoir (“the well head product”) therefore contains a water component that needs to be separated from the oil and gas component to produce a commercially acceptable oil product and gas product. This separation process is typically conducted using at least two separation stages.

The first separation stage of the well-head product typically utilises a vessel called a production separator. The production separator is a large tank or vessel, usually held at or above atmospheric pressure, where the oil, water & gas components stratify via the different components density. The water component separated from the well head product in this first separation stage is known as “Produced water”.

Produced Water is typically of no commercial value, and is therefore disposed of within environmental and/or regulatory limits in the production region. It is therefore necessary to treat the produced water using a second separation stage to treat the water to the required discharge limits. The main residual contaminant in process water is usually residual crude oil, the amount of which can range from 10,000 ppm to 100 ppm, with 250 to 1000 ppm being typical.

In recent years significant changes to environmental regulations around the world have resulted in an overall reduction in the amount of oil that is allowed to be discharged to the environment. Prior to 2000, a typical environmental limit for oil-in-water discharged from an oil & gas production facility may have been 40 ppm. In recent years, this target has been lowered and is now often around 15 ppm, with some regions adopting 5 ppm as a legal limit for surface discharges. There is therefore a greater demand for water treating equipment that is able to reliably and consistently meet these lower oil-in-water limits.

One approach for treating produced water to these lower oil-in-water levels has been to use deoiler hydrocyclones as a primary water treatment device, followed by gas flotation as a secondary water treatment process. Common gas flotation techniques currently used as a secondary water treatment process include dissolved gas flotation and induced gas flotation.

Dissolved gas flotation utilises the dissolved gas content of the produced water to create bubbles to contact and float the oil droplets in the solution.

Induced gas flotation uses a bubble generator such as an eductor nozzle (a venturi type nozzle) or a pump to add gas bubbles to the water for the purpose of removing the residual oil droplets.

While both of these techniques are commonly used for the purpose of recovering oil from a produced water stream, it has been found that:
the use of existing bubble generators can provide limited control over the size of the bubbles generated. In the case of an eductor nozzle, most bubbles are typically too large to assist in oil removal and tend to create a somewhat turbulent environment which is counter-productive to the capture of entrained oil droplets;
chemicals can be required to assist in the recovery of the oil droplets. The use of chemicals adds ongoing costs, and creates the potential for further environmental compliance difficulties in many areas;
a pump is required to produce bubble flow. The use of a pump can have a significant power demand and due to the moving parts within these pumps, requires regular maintenance; and
a gas supply is required to injection of gas into the waste water to generate bubbles. This adds costs and complexity to the process. This gas is often vented to the atmosphere, which can be an undesirable outcome having a significant cost.

It would therefore be desirable to provide an alternative separation process for separating contaminants such as residual crude oil from a produced water stream.

### SUMMARY OF THE INVENTION

According to a first aspect of the present invention, there is provided a bubble generator for generating gas bubbles for a flotation vessel, the bubble generator including:
at least one inlet through which a water stream can enter the bubble generator;
at least one pair of electrodes capable of electrically decomposing water to create gas bubbles; and
at least one outlet through which water entrained with gas bubbles can exit the bubble generator,
wherein, in use, at least one of the outlets is in fluid communication with a flotation vessel containing waste water including contaminants, the gas bubbles being used to separate at least a portion of the contaminants from the waste water in the flotation vessel.

Flotation is a gravity separation process in which gas bubbles contact and attach to contaminants in a solution, thereby reducing their density so that they float to the surface of the liquid. The present invention relates to a type of electroflotation process in which gas bubbles are generated by electrolysis of a liquid. In the case of a water containing liquid, both hydrogen gas and oxygen gas can be generated by electrolysis of (electrically decomposing) part of that water content. Significantly, the use of electrolysis negates the requirement of prior arrangements using pumps and eductors for injecting gas into the waste water, and the associated (prior mentioned) disadvantages of these types of arrangements.

This type of electroflotation electrolytic process generally generates very fine bubbles. The bubbles generated at the electrodes of a bubble generator according to the present invention therefore generally have an average diameter of less than 100 microns, and more preferably less than 50 microns. In most embodiments, the bubbles generated by this electrolytic process have an average diameter of between 5 and 200 microns, and more preferably between 5 and 50 microns.

Without wishing to be limited to any one theory, it should be appreciated that smaller bubbles generally provide a better recovery of contaminants dispersed within waste water streams in flotation. This is largely related to the bubble diameter being proportional to its vertical rising velocity. For waste water containing oil droplets and related contaminants, the oil droplets and contaminants generally have an average diameter of less than 40 micron. This size is similar to the average size of a large proportion of the gas bubbles created by the electrolytic process of the present invention. This size similarity provides an increased probability of coalescence of the bubbles, oil droplets and contaminants, resulting in increased probability of removal of the oil droplets and contaminants from the water stream.

A bubble generator according to the present invention therefore provides an alternate means of producing a dispersion of fine gas bubbles in a water stream that can be used in a flotation vessel to provide a good recovery rate of contaminants in waste water including contaminants contained within the flotation vessel.

Electrolysis of the water in the bubble generator occurs through the use of at least two electrodes. At least one electrode is an anode and at least one electrode is a cathode. The electrodes are electrically connected to a direct current power source. The power source used by the present invention preferably has a voltage of between 5 to 20V, more preferably 5 to 10V, and is supplied at a current density of between 75 to 300 A/m² of electrode, more preferably at about 100 A/m² of electrode. However, it should be appreciated that other power parameter may also be suitable for conducting this type of electrolysis.

Any suitable type of electrode can be used to conduct electrolysis. It should be appreciated that in such an electrolysis process, two general types of electrodes can be used.

In some embodiments, sacrificial electrodes are used in the bubble generator. Examples of suitable sacrificial electrodes are iron based electrodes and aluminium based electrodes. In these embodiments, the aluminium, iron or the like electrodes form metal ions in solution during the electrolysis process which can form a metal hydroxide contaminant in the waste water. However, the production of this type of metal hydroxide contaminant may not be ideal for environmental considerations of a discharge stream in some situations.

In an alternate embodiment, inert electrodes are used in the bubble generator. Inert electrode material is selected to be conductive to electric current flow, but not sacrificial during the electrolysis process. This generally avoids the need to regularly replace the electrodes, thereby avoiding significant cost and down-time in a continuous separation process. Additionally, the use of inert electrodes avoids the production of undesirable metal ions or metal hydroxides within the waste water. Suitable inert electrodes include at least one of titanium, stainless steel, platinum or duriron optionally coated with at least one of lead dioxide, platinum, or ruthenium oxide. In one embodiment, the anode comprises titanium coated with ruthenium oxide and the cathode comprises stainless steel. In another embodiment, the cathode comprises carbon and the anode comprises duriron. As can be appreciated, duriron is a cast alloy having the following nominal composition: silicon ˜14.2 wt. %, carbon ˜0.8 wt. %, balance iron.

The electrodes (anode and cathode) of the bubble generator according to the present invention can have any suitable configuration. Suitable configurations include tubular bars, mesh, plates, perforated plates, a grid structure of plates or bars or the like. Nevertheless, as a general rule, the greater the number of gas bubbles, the higher the probability of these gas bubbles coming into contact with the contaminants, and thus the greater the probability of the contaminants being removed from the waste water. It is therefore preferable for the electrodes of the gas flotation generator to have a large electrode surface area to provide a large bubble generation area. In one embodiment, this bubble generation surface area can be provided through each of the electrodes comprising plates (solid, mesh, grids or the like) arranged in a layered structure within the bubble generator.

A bubble generator according to the present invention can be used to generate bubbles for any suitable water. It should be understood that the term water stream is intended to encompass any water containing stream including but not limited to treated water streams, waste water streams, produced water, town water, salt water or the like. As can be appreciated, the present invention is particularly useful in induced gas flotation applications where the waste water does not have a sufficient dissolved gas content to produce gas bubbles to undergo a dissolved gas flotation process in a flotation vessel. Nevertheless, it should be appreciated that the bubble generator could be used in some embodiments in dissolved gas flotation applications to supplement/improve this flotation process.

The bubble generator according to the present invention can be used in a new flotation system or can be retrofitted into an existing system, for example where it is desirable to improve the contaminant recovery in an existing induced gas flotation system. In this respect, there are many applications where changing laws/regulations and other business motives require separation processes to be improved or altered to provide discharge levels that have a lower contaminant content. In one such retrofit embodiment, a bubble generator according to the present invention is connected in fluid communication with a flotation vessel to replace a pump or eductor nozzle.

The electrolytic process occurring at the electrodes generates gas bubbles that can be used to assist in a flotation separation process. It should be appreciated that the generated gas bubbles can immediately contact any contaminants in the water (if any) in the bubble generator causing separation of the contaminants in this water. However, it should be understood that the main separation process that these generated gas bubbles are intended preferably occurs within a flotation vessel that is in fluid communication with the bubble generator.

According to a second aspect of the present invention, there is provided a flotation separator for separating contaminants from waste water including:
a bubble generator according to the first aspect of the present invention; and
a flotation vessel in fluid communication with the outlet of the bubble generator,
wherein, in use, the flotation vessel is in fluid communication with a waste water stream including contaminants, the water entrained with gas bubbles being mixed with the waste water from the waste water stream to allow gas bubbles to separate at least a portion of the contaminants from waste water within the flotation vessel.

The bubble generator can be in fluid communication with the flotation vessel through any number of suitable water feed streams.

In some embodiments, the bubble generator is fed treated water from the flotation vessel. In such embodiments, the flotation vessel can include an inlet through which water entrained with gas bubbles are fed into the flotation vessel and a water outlet through which treated waste water can flow out of the flotation vessel, the bubble generator being in fluid communication with the water outlet and water inlet of the flotation vessel thereby allowing at least a portion of the treated waste water to flow from the water outlet through the bubble generator and back into the flotation vessel.

In other embodiments, the bubble generator is fed substantially the same waste water that is fed into the flotation vessel. In such embodiments, both the inlet of the bubble generator and an inlet of the flotation vessel can be in fluid communication with a waste water inlet conduit, the ratio of waste water fed to the bubble generator as compared to the flotation vessel being controlled to enhance the separation of contaminants in the flotation vessel.

The flotation vessel can be any suitable tank or vessel in which flotation separation process can be undertaken. Suitable flotation vessels include mechanically agitated cells or tanks, flotation columns, Jameson cells, horizontal flotation tanks, vertical flotation tanks or the like. In one embodiment, the flotation vessel comprises a vertical vessel. In another embodiment, the flotation vessel comprises a horizontal vessel. Preferably, the horizontal vessel includes one or more separation barriers or internal walls which substantially divide the vessel into at least two internal chambers.

It is preferable that the contaminants floated by the gas bubbles are separated from the treated water within the flotation device. In some embodiments, a skimming device or process is used to achieve this contaminant-water separation. Any suitable skimmer arrangement can be used including (but not limited to) weir skimmers, oleophilic skimmers, drum skimmers or the like.

In some embodiments, the flotation vessel includes one or more weir skimmers. Weir skimmers function by allowing the oil floating on the surface of the water to flow over a weir. Preferably, the flotation vessels in these embodiments also include a hydraulic skimming arrangement for enhancing the separation of the surface layer of contaminants from the waste water. In these embodiments, a flotation vessel utilizes hydraulic skimming mechanisms to create surface flow patterns and surface velocity drive surface proximate oil and contaminants to push the contaminant layer over a weir. Of course, this type of skimming generally requires careful placement of the weirs relative to the changer inlets and outlets. Turbulent zones within the vessel are also critical.

In some embodiments, the flotation separator further includes a bubble coalescer following the bubble generator. The bubble coalescer may be located between the bubble generator and the flotation cell, attached to the bubble generator or form part of the flotation cell. The bubble coalescer functions to coalesce the bubbles generated from the bubble generator to larger diameters, where larger size bubbles are preferred for flotation separation. For example, where the bubble generator generates bubbles of between ˜30 to 50 microns, the bubble coalescer may be used to obtain a bubble diameter of between ˜40 to 120 microns. In a preferred form, the bubble coalescer comprises a coalescence pad. However, it should be appreciated that any suitable bubble coalescing technique/system would be applicable.

A flotation separator according to the present invention can be used to separate contaminants from any suitable type of waste water. In one preferred embodiment, the waste water treated in the separation process according to the present invention comprises produced water from a production separator. As can be appreciated, in this embodiment the gas bubbles are used to substantially recover the residual oil content from the produced water. However, it should be appreciated that the gas flotation process will also result in capturing a range of other contaminants that may be present in the water, other than hydrocarbons.

A separation process according to the present invention can be used as a primary treatment process for a waste water stream or can be used in conjunction with other water treatment processes to separate contaminants from the waste water. In some embodiments, the separation process further includes at least one further separation apparatus in fluid communication with the flotation separator. Preferably, the further separation apparatus is selected from flotation separation devices, hydrocyclones, filtration devices, adsorption columns, corrugated or tilted plate interceptors, gravity settling tanks or a combination thereof. The further separation apparatus can be located upstream, in parallel or downstream (relative to the waste water stream) of the bubble generator and flotation vessel. In one embodiment, the bubble generator and flotation vessel are a secondary treatment process having at least one other pre-treatment process located upstream thereof. Preferably, the further separation device includes at least one hydrocyclone connected upstream of the flotation separator.

According to a third aspect of the present invention, there is provided a separation process for separating contaminants from waste water, the process including:
feeding a water stream into a bubble generator including at least one pair of electrodes capable of electrically decomposing water to create gas bubbles;
generating and entraining gas bubbles in the waste water stream using the bubble generator, thereby producing an entrained bubble water stream; and
feeding the entrained bubble water stream into a flotation vessel containing waste water including contaminants, the entrained gas bubbles functioning to separate at least a portion of the contaminants from the waste water in the flotation vessel to produce a treated water.

Again, the contaminants floated by the gas bubbles are preferably separated from the treated water within the flotation device. In some embodiments the separation process can therefore further include the step of separating the portion of the contaminants from the waste water in the flotation vessel using a hydraulic skimming device.

In some embodiments, the separation process can further comprise the step of: coalescing bubbles generated by the bubble generator to form larger bubbles for use in the flotation vessel.

Preferably, the coalescing step is conducted in a bubble coalescing vessel located between the bubble generator and the flotation cell, attached to the bubble generator or forming part of the flotation cell. In a preferred form, the bubble coalesce comprises a coalescence pad. However, it should be appreciated that any suitable technique would be applicable.

The water stream fed into the bubble generator can be sourced from a variety of water sources. In one embodiment, the process further includes the step of feeding at least a portion of the treated water from the flotation vessel into the bubble generator. In another embodiment, the process further includes the step of feeding a first portion of the waste water stream into the flotation vessel and a second portion of the waste water stream into the bubble generator, the ratio of waste water fed to the bubble generator as compared to the flotation vessel being controlled to enhance the separation of contaminants in the flotation vessel.

The separation process according to the third aspect of the present invention is preferably used in a produced water treatment process to separate an oil content from the water content of the produced water. This treatment process preferably produces a water having an oil-in-water content of less than 40 ppm, more preferably less than 15 ppm, even more preferably of less than 5 ppm in order to meet the legal environment surface discharges limit for waste water in a particular region.

### BRIEF DESCRIPTION OF THE DRAWINGS

The present invention will now be described with reference to the figures of the accompanying drawings, which illustrate particular preferred embodiments of the present invention, wherein:

FIG. 1 is a general process flow diagram of a first separation process of a well head product extracted from an oil production platform or facility;

FIG. 2 is a general process flow diagram of a separation process according to a first embodiment of the present invention for treating produced water produced from the first separation process shown in FIG. 1;

FIG. 3 is a general process flow diagram of a separation process according to a second embodiment of the present invention for treating produced water produced from the first separation process shown in FIG. 1; and,

FIG. 4 is a schematic diagram of one bubble generator used in the separation process shown in FIG. 2.

### DETAILED DESCRIPTION

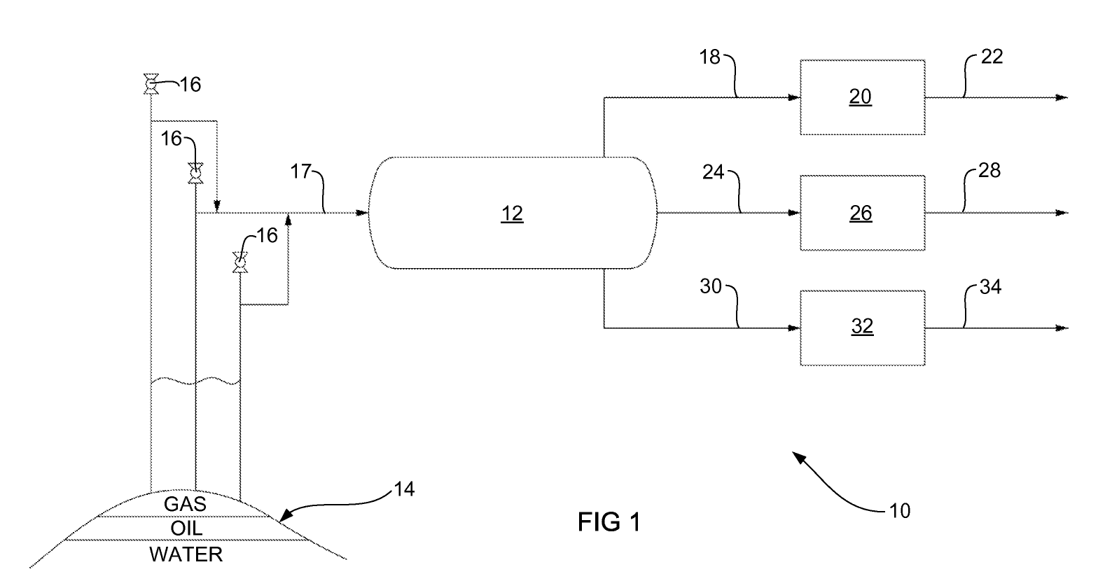

FIGS. 1 to 4 illustrate a treatment process for produced water resulting from a production separator 12 used in a first separation stage 10 in the course of oil and/or gas production in the petroleum industry.

Referring to FIG. 1, there is shown a basic flow diagram providing the general flow paths of materials in the first separation stage 10 of a well head product extracted from an oil/gas well 16. Preceding the first separation stage 10, a well head oil product is extracted from an oil and/or gas reservoir 14 via an oil/gas well 16. The well head product typically comprises a mix of oil, gas, water and other contaminants. The well head product is fed from the oil/gas wells 16 to the production separator 12 through inlet stream 17 to undergo the first separation stage 10.

The illustrated production separator 12 is a large tank held at or above atmospheric pressure. The well head product is fed into the production separator 12 and allowed to settle for a settling period. During this settling period, the oil, water & gas contents substantially stratify and separate due to the density differences of these components. Any solids, such as sand, will also settle in the bottom of the production separator 12.

A gas product is removed from the production separator 12 as an overhead or top stream 18. The gas product is subsequently treated using various treatment processes 20 to produce a commercial natural gas product 22.

The oil and water content substantially separate into an upper oil rich layer and a lower water rich layer within the production separator 12. These layers are separated using a baffle or weir (not shown) located at the end of the production separator 12 which is set at a height close to the oil-water boundary. When the oil and water content contact the baffle, the upper oil rich layer spills over the baffle into a receptacle and then exits the production separator 12 as liquid stream 24. The oil rich product is subsequently treated using various treatment processes 26 to produce a commercial oil product 28. The remaining water rich content exits the production separator 12 as liquid stream 30. This water rich content is known as “produced water”. This produced water stream 30 is treated using various treatment processes 32 to produce a water product 34 meeting the environmental discharge requirements for the particular location that the oil and/or gas reservoir 14 is located. It should however be appreciated that there are many other separator configurations available that conduct a similar separation process to result in produced water.

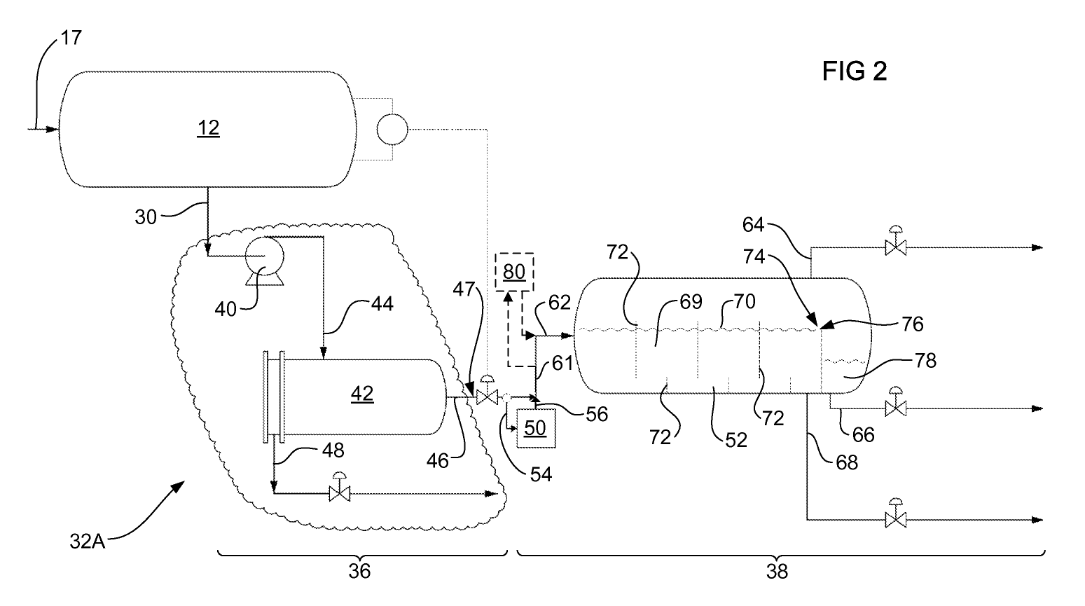

Referring now to FIG. 2, there is shown one embodiment of a treatment process 32A for treating the produced water stream 30 from the production separator 12. The illustrated treatment process 32A includes two treatment stages. A primary treatment stage 36 is conducted using a hydrocyclone treatment process. A secondary treatment stage 38 is conducted using a flotation separation process according to one embodiment of the present invention. It should be appreciated that the primary treatment stage 36 is optional. Accordingly, the illustrated treatment process 32A may not include primary treatment stage 36 in some embodiments.

In the primary treatment stage 36, the produced water stream 30 is fed via booster pump 40 to a deoiler cyclone 42. It should be appreciated that booster pump 40 is optional, and is only required when pressure in the produced water stream 30 is too low (typically below 500 kPag). A deoiler cyclone 42 is a form of hydrocyclone that can be used to classify/separate an emulsion based on the specific gravity of the components in the emulsion. Deoiler cyclones are driven by inlet water pressure and utilise a pressure drop across the cyclone to provide the energy or driving force to cause oil-water separation. In the illustrated process, the booster pump 40, a single stage centrifugal pump, is used to increase the feed pressure of the produced water stream 30 to optimise the separation process within the deoiler cyclone 42. The illustrated deoiler cyclone 42 includes a tangential inlet 44 through which the water enters the deoiler cyclone 42, and is forced to spin rapidly, generating high centripetal forces. These forces, combined with a tapering internal profile shape (not shown) accelerate the spinning. This forces the water content of the produced water away from the centre axis of the deoiler cyclone 42 to the outer walls, and forces the lower density oil to a central core that forms along the axis of the deoiler cyclone 42. Primary treated produced water exits the deoiler cyclone 42 through a water outlet nozzle 46 into stream 47. The central oil core exits through oil reject outlet 48. Suitable deoiler cyclones 42 include the CYCLONIXX® type deoiler cyclone available from the applicant, Process Group Pty. Ltd.

The illustrated secondary treatment stage 38 is an induced gas type flotation separation process. Induced gas flotation typically uses an external device to add gas bubbles to the waste water being treated. The gas bubbles contact and attach to contaminants, such as oil droplets in solution, reducing the contaminants density and thereby floating the contaminants to the surface of the liquid.

The secondary treatment stage 38 includes two process units, being a bubble generator 50 and a flotation vessel 52.

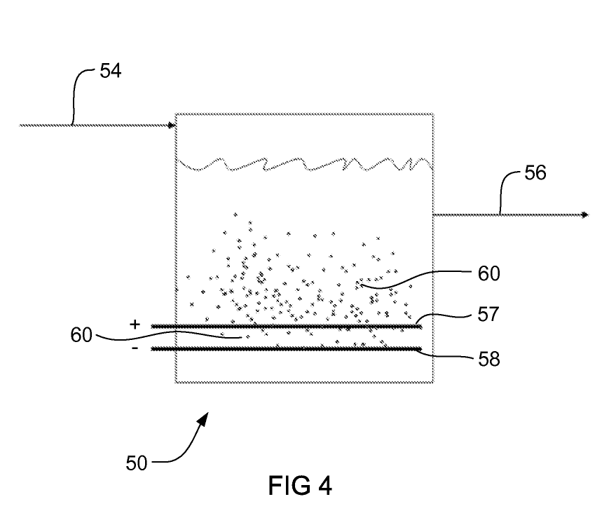

The bubble generator 50 is an electrolytic bubble generator that uses an electrolytic process to produce bubbles in water. As shown in FIG. 4, the bubble generator 50 is a process vessel or apparatus (which may or may not be pressurised) having an inlet 54 through which water can flow into the bubble generator 50 and an outlet 56 through which water entrained with gas bubbles can exit the bubble generator 50. The outlet 56 is in fluid communication with the flotation vessel 52.

The bubble generator 50 also includes at least two electrodes 57, 58. At least one electrode is an anode 57 and at least one electrode is a cathode 58 electrically connected to a direct current power source. The electrodes 57, 58 of the illustrated bubble generator 50 are inert electrodes. In this regard, the material each electrode 57, 58 are made from do not dissolve or otherwise react during electrolysis. In the illustrated embodiment, the anode 57 is made of titanium coated with ruthenium oxide and the cathode 58 is made of stainless steel. The illustrated electrodes 57, 58 are shown as tubular bars. However, it should be appreciated that the electrodes 57, 58 can have any suitable configuration including mesh, plates, perforated plates, a grid structure of plates or bars, or the like.

In the illustrated embodiment, the power source used by the present invention has a voltage of between 5 to 10V and is supplied at a current density of about 100 A/m² of electrode. Applied DC power causes electrolysis at the electrodes creating oxygen gas and hydrogen gas. These gases form as gas bubbles 60 in the liquid on the surface of the relevant electrodes 57, 58. Once a bubble 60 is large enough to overcome surface forces, that bubble 60 moves from the surface of the relevant electrode 57, 58 into the liquid. The general electrolysis reactions for gas generation at the electrodes 57, 58 are:

Anode: 2H₂O=O_{2(g)}+4H⁺

Cathode: 2H⁺+2e=H_{2(g)}

However, it should be appreciated that other half reactions are possible at the electrodes 57, 58 which result in the production of gas and other products. The gas bubbles 60 generated by this electrolysis reaction are typically very fine bubbles having an average diameter of between 5 and 200 microns, though most bubbles 60 generally have an average diameter less than 50 microns. As discussed previously, smaller bubbles 60 generally provide a better recovery of contaminants dispersed on produced and/or waste water streams in a flotation vessel 52. This is largely related to the bubble diameter being proportional to its vertical rising velocity. For waste water, such as produced water containing oil particles and related contaminants, these oil particles and contaminants typically have an average diameter of less than 40 micron. This size is similar to the average size of a large proportion of the gas bubbles 60 created by the electrolytic process in the bubble generator 50. This provides an increased probability of coalescence of the two, resulting in increased probability of removal of the oil droplets and other contaminants from the produced water within the flotation vessel 52.

The gas bubbles 60 generated in the bubble generator 50 are fed into a flotation vessel 52. In the separation process 38 shown in FIG. 2, the bubble generator 50 is fed from stream 54. Stream 54 is a side stream of stream 47, the main flow stream for the primary treated produced water that exits the deoiler cyclone 42. The stream split of stream 54 to stream 47 can be anywhere from between 5 to 100% (preferably between 25 to 75%) depending on the amount of gas bubbles needed to be entrained into the primary treated produced water entering the flotation vessel 52 to achieve a good separation of oil and other contaminants within the flotation vessel 52. In most applications, this split can be achieved by means of a restricting device placed on the main feed stream 47, where a selected percentage of the primary treated process water is passed through the bubble generator 50, while a selected percentage bypasses the bubble generator 50 and is fed directly into the flotation vessel 52. This allows the size of the bubble generator 50 to be minimised along with the power consumption required. The primary treated produced water flowing into the bubble generator 50 is subject to electrolysis so as to generate and entrain gas bubbles 60 within the primary treated produced water. This entrained bubble water exits the bubble generator 50 via outlet 56 and rejoins inlet stream 61 to be fed through inlet 62 into the flotation vessel 52.

The illustrated flotation vessel 52 is a horizontal vessel including an inlet 62, an upper gas outlet 64, an oil product outlet 66 and a treated water outlet 68. It should be appreciated that in other embodiments the flotation vessel 52 may be a vertical vessel. Produced water from stream 61 is fed into the flotation vessel 52. The entrained bubbles 60 contact oil droplets and other contaminants in the produced water 69 in the flotation vessel 52 and float these oil droplets and other contaminants to the surface 70 of the water 69 in the flotation vessel 52. The illustrated flotation vessel 52 includes a number of separation barriers, baffles 72 along the length of the flotation vessel 52. The oil droplets and contaminants floated to the surface 70 of the water 69 by the gas bubbles are separated from the treated water within the flotation device using a weir skimmers arrangement 74. The weir skimmers arrangement 74 includes a weir 76 positioned at the oil-water junction. Oil at the surface 70 can flow over the weir 76 into an oil receiving section 78. The water is trapped behind the weir 76. The illustrated flotation vessel 52 also includes hydraulic skimming mechanisms to create surface flow patterns and surface velocity drive surface proximate oil and contaminants to push the oil and contaminant layer over the weir 76. The oil rich product exits oil outlet 66, the treated water product exits water outlet 68, and any gas in the head of the flotation vessel 52 can be extracted through gas outlet 64.

The treatment process 32A may optionally further include a bubble coalescer 80, such as a coalescence pad, following the bubble generator 50 where larger size bubbles are preferred for flotation separation. The illustrated bubble coalescer 80 is located between the bubble generator 50 and the flotation vessel 52. However, in other embodiments (not illustrated) the bubble coalescer may be formed integrally with the bubble generator 50 or form part of the flotation vessel 52. The bubble coalescer 80 functions to coalesce the bubbles generated from the bubble generator 50 to a larger size. For example, where the bubble generator 50 generates bubbles of between ˜30 to 50 microns, the bubble coalescer 80 could be used to obtain a bubble diameter of between ˜40 to 120 microns.

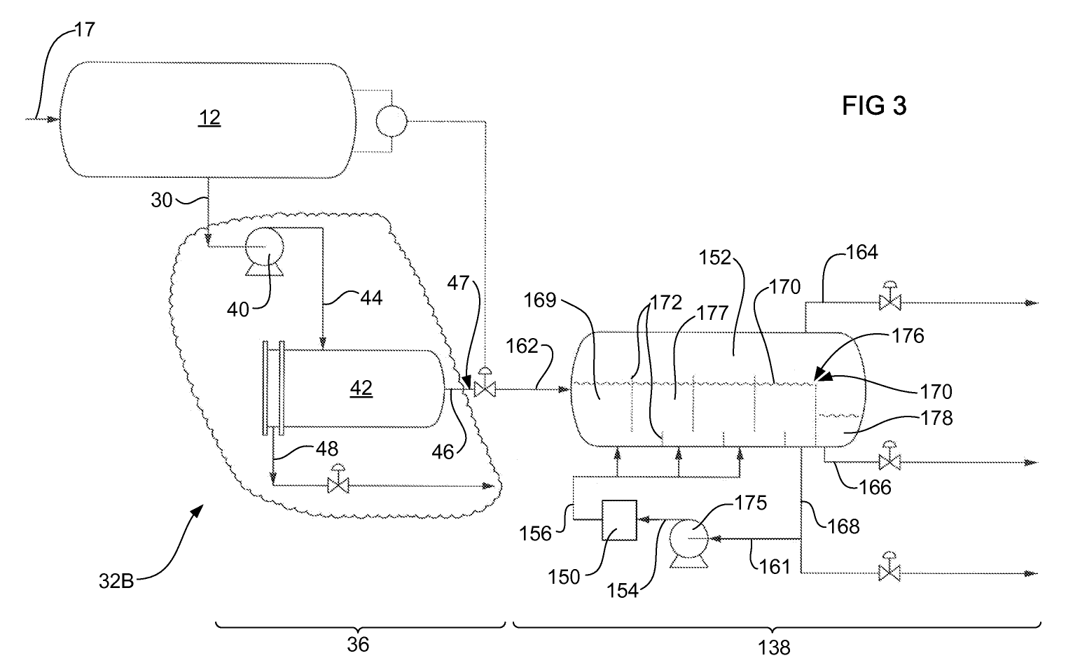

FIG. 3 shows an alternative embodiment of a treatment process 32B for treating produced water stream 30 produced from a production separator 12. Again, the illustrated treatment process 32B includes two treatment stages, a primary treatment stage 36 comprising a hydrocyclone treatment process and a secondary treatment stage 138 comprising a flotation separation process according to another embodiment of the present invention. Again, it should be appreciated that the primary treatment stage 36 is optional.

The illustrated primary treatment stage 36 shown in FIG. 3 is substantially the same as the primary treatment stage 36 shown in FIG. 2. Accordingly, it should be understood that the same reference numerals have been used in FIG. 3 as those used for similar components shown in FIG. 2 and that the above description for the primary treatment stage 36 described in relation to FIG. 2 can equally apply for the primary treatment stage 36 shown in FIG. 3.

The illustrated secondary treatment stage 138 is also an induced gas type flotation separation process which includes two process units, being a bubble generator 150 and a flotation vessel 152. It should be understood that as the secondary treatment stage 138 shown in FIG. 3 is similar to the secondary treatment stage 38 shown in FIG. 2, like features have been indicated with the same reference numeral as used in FIG. 2 plus 100. It should also be understood that the above description for the secondary treatment stage 38 described in relation to FIG. 2 can equally apply for the similar aspects of the secondary treatment stage 138 shown in FIG. 3.

This embodiment of the secondary treatment stage 138 also uses an electrolytic bubble generator 150 to generate and entrain gas bubbles in a water stream fed into the bubble generator 150. The gas bubbles generated in the bubble generator 150 are fed into the flotation vessel 152. The illustrated flotation vessel 152 is also a horizontal vessel similar to the flotation vessel 52 as described in relation to the embodiment shown in FIG. 2. It should be appreciated that in other embodiments the flotation vessel 152 may be a vertical vessel. Again, the oil rich product exits oil outlet 166, the treated water product exits water outlet 168, and any gas in the head of the vessel 152 can be extracted through gas outlet 164.

The separation process 138 shown in FIG. 3 differs from the separation process 38 shown in FIG. 2 with respect to the water stream fed into the bubble generator 150. In this embodiment, a side stream 161 of treated water (anything from 5-25% of the throughput flow-rate) is taken from the outlet 168 of the flotation vessel 152, and pumped back via pump 175 to the inlet 154 of the bubble generator 150. The bubble generator 150 electrolytically entrains gas bubbles into the water from this water stream 154. This recycled stream 156 of water with entrained gas bubbles can then be returned to the inlet 162 of the flotation vessel 152, or, as illustrated, to individual chambers 177 within the flotation vessel 152. This embodiment has the advantage of feeding water into the bubble generator 152 which has been treated in flotation vessel 152 and therefore has a lower concentration of contaminants as compared to the water feed into the flotation vessel 152 from stream 162. In some cases the water from this water stream 161 is substantially free of contaminants. Accordingly, comparably less contaminants (and in some cases little to no contaminants) are separated from the fed water during bubble generation within the bubble generator 150 reducing the need to regularly clean the bubble generator 150. However, this embodiment of the separation process 138 requires an additional pump 175 as compared to the separation process 38 shown in FIG. 2 and therefore additional power to run this pump 175.

It should be appreciated, that the separation processes of the secondary treatment stages 38 and 138 shown in FIGS. 2 and 3 can be subject to optimisation to the fluid flow inside the flotation vessels 52, 152, so that short-circuiting of oily water is minimised (to maximise oil recovery) and skimming operations are optimised. This can be guided by CFD (Computational Fluid Dynamics). The separation processes of the secondary treatment stages 38 and 138 can also be optimised by controlling the gas bubbles generated by the electrolysis process used to assist in the capture of residual oil droplets. As discussed, this would involve optimising the size and amount of gas bubbles generated on the electrodes 57, 58 of the bubble generator 50, 150.

It should also be appreciated that the bubble generator 50, 150 can be used in a new flotation system or be retrofitted into an existing system, for example where it is desirable to improve the contaminant recovery in an existing induced gas flotation system.

Those skilled in the art will appreciate that the invention described herein is susceptible to variations and modifications other than those specifically described. It is understood that the invention includes all such variations and modifications which fall within the spirit and scope of the present invention.

Throughout the description and claims of the specification the word “comprise” and variations of the word, such as “comprising” and “comprises”, is not intended to exclude other additives, components, integers or steps.

We claim:

1. A bubble generator for generating gas bubbles for a flotation vessel, the bubble generator comprising:
at least one inlet through which a water stream can enter the bubble generator;
at least one pair of electrodes capable of electrically decomposing water to create gas bubbles; and
at least one outlet through which water entrained with gas bubbles can exit the bubble generator,
wherein, in use, at least one of the outlets is in fluid communication with a flotation vessel containing waste water including contaminants, the gas bubbles being used to separate at least a portion of the contaminants from the waste water in the flotation vessel.

2. The bubble generator according to claim 1, wherein each of the electrodes are inert electrodes.

3. The bubble generator according to claim 2, wherein each of the electrodes include at least one of titanium, stainless steel, platinum or duriron, optionally coated with at least one of lead dioxide, platinum, or ruthenium oxide.

4. The bubble generator according to claim 1, wherein each of the electrodes comprises plates arranged in a layered structure within the bubble generator.

5. The bubble generator according to claim 1 connected in fluid communication with a flotation vessel to replace a pump or eductor nozzle.

6. A flotation separator for separating contaminants from waste water comprising:
a bubble generator for generating gas bubbles for a flotation vessel, the bubble generator having at least one inlet through which a water stream can enter the bubble generator, at least one pair of electrodes capable of electrically decomposing water to create gas bubbles, and at least one outlet through which water entrained with gas bubbles can exit the bubble generator; and,
a flotation vessel in fluid communication with the at least one outlet of the bubble generator,
wherein, in use, the flotation vessel is in fluid communication with a waste water stream including contaminants, the water entrained with gas bubbles being mixed with the waste water from the waste water stream to allow gas bubbles to separate at least a portion of the contaminants from the waste water within in the flotation vessel.

7. The flotation separator according to claim 6, wherein the flotation vessel includes a inlet through which water entrained with gas bubbles are fed into the flotation vessel and a water outlet through which treated waste water can flow out of the flotation vessel, the bubble generator being in fluid communication with the water outlet and water inlet of the flotation vessel thereby allowing at least a portion of the treated waste water to flow from the water outlet through the bubble generator and back into the flotation vessel.

8. The flotation separator according to claim 7, wherein both the inlet of the bubble generator and an inlet of the flotation vessel is in fluid communication with a waste water inlet conduit, the ratio of waste water fed to the bubble generator as compared to the flotation vessel being controlled to enhance the separation of contaminants in the flotation vessel.

9. The flotation separator according to claim 6, wherein the flotation vessel comprises a horizontal vessel or a vertical vessel.

10. The flotation separator according to claim 6, wherein the flotation vessel includes a hydraulic skimming arrangement for separating the surface layer of contaminants from the waste water.

11. The flotation separator according to claim 6, wherein the waste water comprises produced water from a production separator used in the first separation step of a well head product obtained from an oil and gas production operation.

12. The flotation separator according to claim 6, wherein the gas bubbles are used to substantially recover an oil content from the produced water.

13. The flotation separator according to claim 6, further including at least one further separation apparatus in fluid communication with the flotation separator, the further separation apparatus being selected from flotation separation devices, hydrocyclones, filtration devices, adsorption columns, corrugated or tilted plate interceptors, gravity settling tanks or a combination thereof.

14. The flotation separator according to claim 13, wherein the further separation device includes at least one hydrocyclone connected upstream of the flotation separator.

15. The flotation separator according to claim 6, further including a bubble coalescer following the bubble generator.

16. A separation process for separating contaminants from waste water, the process comprising:
feeding a water stream into a bubble generator including at least one pair of electrodes capable of electrically decomposing water to create gas bubbles;
generating and entraining gas bubbles in the waste water stream using the bubble generator, thereby producing an entrained bubble water stream; and
feeding the entrained bubble water stream into a flotation vessel containing waste water including contaminants, the entrained gas bubbles functioning to separate at least a portion of the contaminants from the waste water in the flotation vessel to produce a treated water.

17. The separation process according to claim 16, further comprising the step of separating the portion of the contaminants from the waste water in the flotation vessel using a hydraulic skimming device.

18. The separation process according to claim 16, further comprising the step of feeding at least a portion of the treated water from the flotation vessel into the bubble generator.

19. The separation process according to claim 16, further comprising the step of feeding a first portion of the waste water steam into the flotation vessel and a second portion of the waste water stream into the bubble generator, the ratio of waste water fed to the bubble generator as compared to the flotation vessel being controlled to enhance the separation of contaminants in the flotation vessel.

20. The separation process according to claim 16, further comprising the step of:
coalescing bubbles generated by the bubble generator to form larger bubbles for use in the flotation vessel.
